(19) United States
(12) Patent Application Publication
(10) Pub. No.: US 2007/0250375 A1
(43) Pub. Date: Oct. 25, 2007

(54) Dynamic Capture Rate Performance Metric

(76) Inventors: William McClellan, Havertown, PA (US); Lisa Kerber, Lafayette Hill, PA (US)

Correspondence Address: BAKER BOTTS L.L.P., 30 ROCKEFELLER PLAZA, 44TH FLOOR, NEW YORK, NY, 10112-4498, US

(21) Appl. No.: 11/677,981

(22) Filed: Feb. 22, 2007

Related U.S. Application Data
(60) Provisional application No. 60/776,710, filed on Feb. 24, 2006.

(51) Int. Cl. G06F 17/30

(52) U.S. Cl. 705/10

(57) ABSTRACT

Techniques for evaluating the performance of two or more products in a market are disclosed. In a preferred embodiment, a method is presented which involves defining the market and identifying the two or more competing products which exist in the market. The number of unique product selection decisions made within the market is then determined. Then the number of unique product selection decisions made for each of the products within the market is determined. Finally, a performance metric is created by calculating the percentage of unique product selection decisions made for each of the products within the market in relation to the total number of unique product selection decisions made within the market.

### CROSS-REFERENCE TO RELATED APPLICATIONS

This application claims priority from U.S. provisional application 60/776,710 filed on Feb. 24, 2006, entitled “Dynamic Capture Rate Performance Metric,” which is hereby incorporated by reference in its entirety.

### BACKGROUND

1. Technical Field

The present invention relates to techniques for measuring the performance of two or more products in a market, and more specifically, to such techniques for measuring the performance of two or more drug brands in the prescription pharmaceutical market.

2. Background Art

Pharmaceutical companies and others in the health-care industry track the performance of different drug brands in the market to determine where advertising dollars should be spent, which field should be allocated research and development funds, how different brands should be priced, and the production capacity necessary to satisfy future demand. Currently, indicators such as total dispensed prescriptions (“TRx”), which measures the total number of prescriptions for a particular brand filled at pharmacies, and newly dispensed prescriptions (“NRx”), which measures only new prescriptions and not refills, are used as metrics of the performance of various brands in the prescription drug market.

However, TRx is a trailing indicator and often only allows the user to identify a trend after the effects are already being felt, at which time it may be too late for a corporation to effectively alter its behavior in response to the trend, while NRx is a leading indicator, but may be unreliable and does not provide much lead time. Accordingly, there exists a need for a cost-effective, reliable, easily-implemented metric which acts as a leading indicator for brand performance, allowing accurate estimates of product performance in the near future.

### SUMMARY

An object of the present invention is to provide a technique for implementing a prescription drug performance metric which acts as a leading indicator for the performance of a prescription drug in a particular market as well as a predictor of future TRx performance.

In order to meet this and other objectives which will be apparent with reference to the disclosure herein, the present invention provides techniques for evaluating the performance of two or more products in a market. In some embodiments, the present invention provides a process which includes four steps. First, the market and the products competing within the market are defined. Then the number of unique prescription decisions made within the market is determined. At the market level, these include New Therapy Starts and Add-on Therapies. Next, the number of unique prescription decisions made to prescribe each brand within the market is determined. At the individual drug level, these include New Therapy Starts, Add-on Therapies, and Net Switch Therapies. For a newly launched drug, Net Switch Therapies is calculated by determining the number of patients who Switched To the drug, while for drug that has been on the market, it is calculated by subtracting those patients who Switched From the drug from those who Switched To the drug. Finally, the percentage of unique prescription decisions for each drug is calculated from the total unique prescription decisions in the market.

The process addresses industry needs for a both a better leading indicator as well as a predictive indicator of brand performance. Through the manipulation of already-available longitudinal prescription data (LRx), users can identify trends in the numbers of prescriptions filled before the total prescription numbers are greatly affected. This allows for faster response to negative trends and better planning for future demand.

The accompanying drawings, which are incorporated and constitute part of this disclosure, illustrate preferred embodiments of the invention and serve to explain the principles of the invention.

### BRIEF DESCRIPTION OF THE DRAWINGS

FIG. 1 is a functional diagram of an exemplary system and process in accordance with the present invention.

FIG. 2 is a flow diagram illustrating an example of a process which may be implemented in the system of FIG. 1;

FIG. 3 is a flow diagram illustrating a preferred process for determining the number of unique product selection decisions made within the market in FIG. 2;

FIG. 4 is a flow diagram illustrating a preferred process for determining the number of unique product selection decisions made for each of the products within the market in FIG. 2; and

FIG. 5 is a flow diagram illustrating an alternative process for determining the number of unique product selection decisions made for each of the products within the market in FIG. 2.

While the present invention will now be described in detail with reference to the Figs., it is done so in connection with the illustrative embodiments.

### DETAILED DESCRIPTION

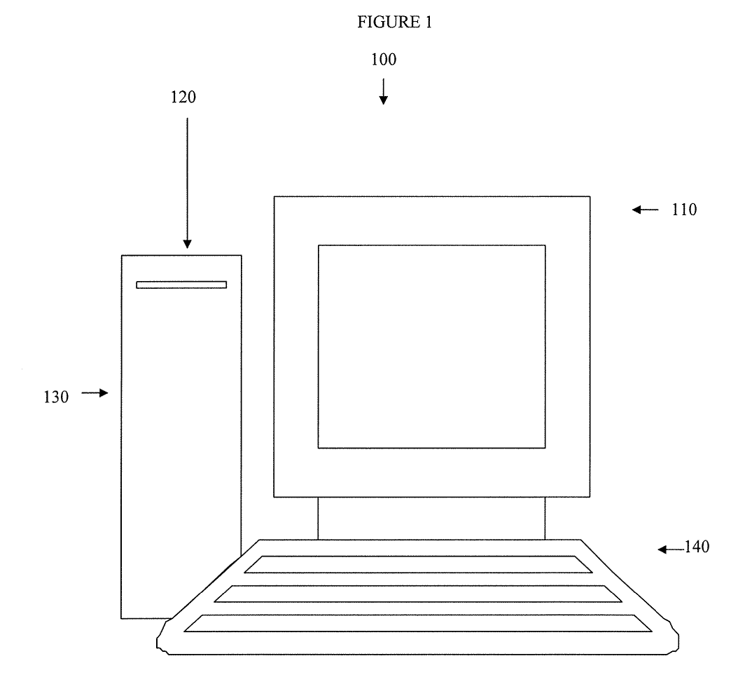

Referring to FIG. 1, a preferred arrangement of the present invention will be described with respect to a process that may be performed manually or on a system 100, including a computer 110, with a memory 120, processor 130, and data entry device 140. In an exemplary embodiment, system 100 includes a UNIX computer platform using SAS software stored in memory 120. Computer 110 is a PC, but may be any form of conventional computer. Memory 120 is a hard drive, but may be any form of accessible data storage, while Processor 130 may be any type of conventional processor. Data entry device 140 is a keyboard, but may also include other data entry devices such as a mouse, an optical character reader, or an internet connection for receiving electronic media. Although the invention will now be described with reference to this exemplary embodiment, those of ordinary skill in the art will appreciate that the invention may be practiced by other than the described embodiment.

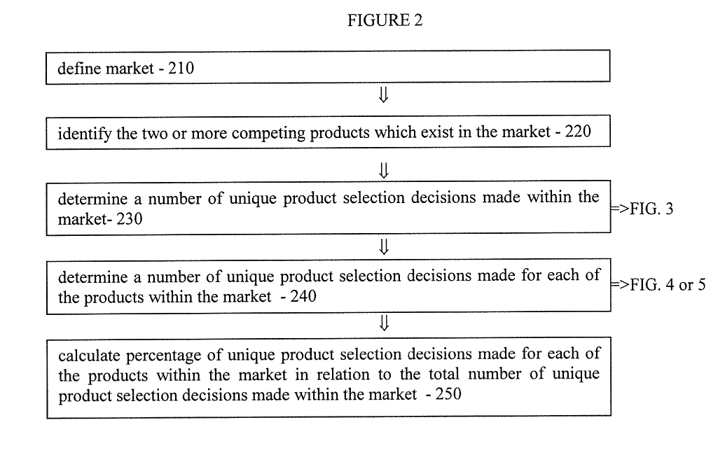

Referring next to FIG. 2, a process for evaluating the performance of two or more products in a market will be described. At 210, the market, which usually consists of the population of individuals suffering from an identical condition that is treated by prescription pharmaceuticals, must be defined. Next, 220, the products that compete in the market are identified. These products are usually those prescription pharmaceuticals that treat the same condition.

To facilitate this analysis, patients may be classified into seven separate groups: Monotherapy New to Market, Monotherapy Continued, Monotherapy Switch, Concomitant New To Market, Concomitant Continued, Concomitant Add-On, and Concomitant Switch. The criteria for each group is as follows.

The Monotherapy New group contains patients who initiate therapy on a single product of interest and had no prior market therapy. Patients in this group have had only one product dispensed in the current month and no market products dispensed in the prior 12 months.

The Monotherapy Continued group includes patients who remained on the same single product that was previously dispensed. Patients in this group have had only one product dispensed in the current month, the first prior product dispensed in the prior 12 months was the same product as the current month's product, and any different products dispensed prior to the first prior product do not overlap any days with the first prior product. It is permissible for the first prior product to have any amount of overlap or no overlap with the current month's product. This allows the inclusion in this group of patients reinitiating the same monotherapy after a gap in therapy.

Alternatively, if there is no market therapy in the current month and the first prior therapy is monotherapy (only one product dispensed in the prior month) that overlaps into the current month by at least seven days and any different products dispensed prior to the first prior product did not overlap any days with the first prior product, then the patient is included in the Monotherapy Continued group.

The Monotherapy Switch group includes patients who switch from therapy with one or more products to a single product. Patients in this group have had only one product dispensed in the current month and the end of the prescription for the first prior product in the prior 12 months and any other concomitant therapy with this first prior product leaves a gap of at least one day before the start of the prescription in the current month. A patient can switch from one or more products to monotherapy as long as there is a gap of at least one day between the end of the prescription for the one or more products and the start of the prescription for the product in the current month.

Alternatively, if there is no market therapy in the current month and only one product in the first prior therapy overlaps into the current month by at least 7 days and there is no gap between the first prior therapy and the one or more prescriptions filled before it, then the patient is included in the Monotherapy Switch group. At least one product in the prior regimen must be different than the current therapy

The Concomitant New group contains those patients who initiate therapy on more than one product and were not receiving any prior market product. Patients in this group have had two or more products dispensed in the current month and no market products dispensed in the prior 12 months.

The Concomitant Continue group includes patients who remain on the same combination of two or more products that were dispensed previously. Two or more products are dispensed to the patient in the current month and the first prior therapy consists of the same products as in the current month, where the first prior therapy includes the prescription filled immediately prior to the first day of the current month plus any other product that overlaps it by one or more days. It is permissible for the first prior concomitant products to have any amount of overlap or no overlap with the current month's therapy. Thus, this category may include patients reinitiating the same concomitant therapy after a gap in therapy.

Alternatively, if there is at least one product dispensed to the patient in the current month, all of the products that are part of the current therapy were also part of the first prior concomitant therapy (i.e., the most recently prior therapy and anything concomitant with it), and all prior therapy that was not dispensed in the current month overlaps with the first prescription in the current month by one day or more, the patient is included in the Concomitant Continued group.

Also alternatively, if there is no market therapy in the current month and the first prior therapy is concomitant therapy (more than one product dispensed in the prior month) that overlaps into the current month by at least seven days, then the patient is in the Concomitant Continued group.

The Concomitant Add-on group includes patients who add at least one current product to a prior therapy resulting in concomitant therapy. One or more products are dispensed to the patient in the current month and the first prior prescription (in the prior 12 months) and any other concomitant therapy with this first prior product overlaps by at least one day the prescription(s) for the product(s) in the current month. This group includes patients who add one product to one product, two products to one product, one product to two products, etc.

Alternatively stated, if all the products in the patient's prior regimen (where the prior regimen includes the most recent prior product and any products concomitant with it) are also products in the patient's current regimen, and the patient has at least one product in the current regimen that is not in the prior regimen, then the patient should be in the Concomitant Add-On group.

In a situation where a patient switches from Product A to Product B, where a prescription for Product B is filled before Product A runs out, the patient should be initially placed in the Concomitant Add-On group in the current month, and then placed in one of the Switch groups in the next month (if Product A is not refilled).

The Concomitant Switch group contains those patients who switch from one or more products to a different combination of concomitant products. Two or more products are dispensed to the patient in the current month and the first prior prescription (in the prior 12 months) and any other concomitant therapy with this first prior product leaves a gap of at least one day before each product in the current month. However, gaps between prior products are required only for all products that are not part of the current regimen. If the same product(s) are both prior and current, it is irrelevant if they overlap into the current month. A patient can switch from one or more products to concomitant therapy with two or more products.

Alternatively, if one or more products are dispensed to the patient in the current month and the first prior prescription (in the prior 12 months) and any other concomitant therapy with this first prior product overlap by at least one day with the product(s) in the current month and at least one product leaves a gap of at least one day before the study product(s) in the current month, then the patient may be categorized in the Concomitant Switch group.

Also alternatively, if no market products are dispensed in the current month and at least two products are concomitant with the first prior prescription dispensed in the prior 12 months and at least two of these prior concomitant products overlap into the current month by at least seven days and at least one product does not overlap, then the patient may be categorized in the Concomitant Switch group. At least one product in the prior regimen must be different than the current therapy regimen.

The preceding categories allow a researcher to substantially completely categorize all of the patients that are part of the defined market. However, to prevent a patient from appearing to be concomitant with two or more prescriptions that would normally not be taken together, a series of Concomitancy Restrictions are incorporated into the process.

When determining a patient's therapy for the current month, the oldest prescriptions that violate the established concomitancy restrictions should be dropped from that patient's regimen (that is, only the most recent of these prescriptions should be retained). This occurs for both the patient's current therapy as well as their prior therapy, and may potentially cause that patient to move to another product classification, although it is also possible that there may be no change in a patient's grouping after a particular prescription is dropped. Examples of these restrictions are listed below.

Statins (a class of pharmaceuticals used to treat high cholesterol) cannot be used concomitantly with other Statins. If two are determined to be concomitant according to the above rules, the most recent prescription should be retained and the prior one(s) dropped. Patients with prescriptions for two or more different statins filled on the same day should be excluded from the analysis, as it is rare that a physician would intentionally prescribe multiple statins

Fibrates (usually used as an accessory therapy to treat high cholesterol in association with Statins) cannot be used concomitantly with other Fibrates. If two are determined to be concomitant according to the above rules, the most recent prescription should be retained and the prior one(s) dropped. Patients with prescriptions for two or more different fibrates filled on the same day should be excluded from the analysis.

Bile Acid Sequestrants (usually used in place of Fibrates to treat high cholesterol in association with Statins) cannot be used concomitantly with other Bile Acid Sequestrants. If two are determined to be concomitant according to the above rules, the most recent prescription should be retained and the prior one(s) dropped. Patients with prescriptions for two or more different BASs filled on the same day should be excluded from the analysis.

Products that are broken out by strength (e.g., Lipitor, Pravachol, and Zocor) cannot be concomitant among different strengths of the same product. If two strengths of the same product are determined to be concomitant according to the above rules, the most recent prescription should be retained and the prior one(s) dropped. Patients with prescriptions for two or more different strengths filled on the same day should be excluded from the source of business analysis.

Vytorin cannot be concomitant in a regimen with another Statin. Vytorin also cannot be concomitant in a regimen with Zetia. If the regimen contains Vytorin and Zetia and a statin, find the most recent of Zetia, the statin and Vytorin. If the most recent is Vytorin then the Zetia and the statin should be dropped. If the most recent is Zetia then only the Vytorin should be dropped. If the most recent is the statin then only the Vytorin should be dropped. If the regimen contains Vytorin with either Zetia or a statin then the most recent of the Vytorin or the other drug should be kept (so that the resulting regimen contains either Vytorin or Zetia or the statin).

Once the patients are classified into each of these categories, the Monotherapy Continued and Concomitant Continued groups are removed from consideration, and the remaining groups are used in the analysis.

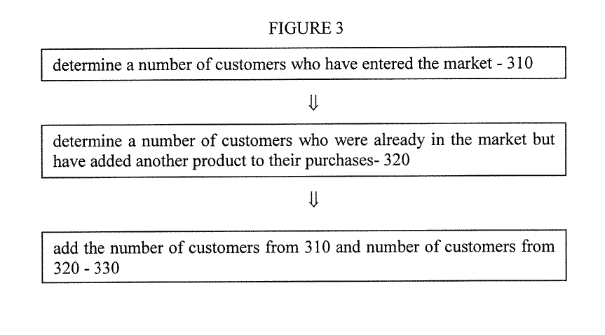

At 230, the total number of unique product selection decisions made within the market is determined. This is usually the total number of pharmaceutical selection decisions made by prescribing physicians for their patients that are within the market. At the market level, unique prescription decisions are defined by New Therapy Starts and Add-on Therapies. Referring to FIG. 3, a highly preferred arrangement is further discussed.

At 310, the number of customers (as measured by the number of prescriptions) who have entered the market is determined. This is usually the number of New Therapy Starts, which are patients who have started a therapy for the first time, and consists of the Monotherapy New to Market and Concomitant New to Market groups.

At 320, the number of customers who were already in the market but have added another product to their purchases is determined. This is usually the number of Add-on Therapies, which are those patients who are currently already on a therapy and have had a new therapy added, and consists of the Concomitant Add-on group. These are calculated based on aggregate totals for every brand combined.

At 330, the total number of unique product selection decisions made within the market is determined by adding the numbers determined in 310 and 320 together.

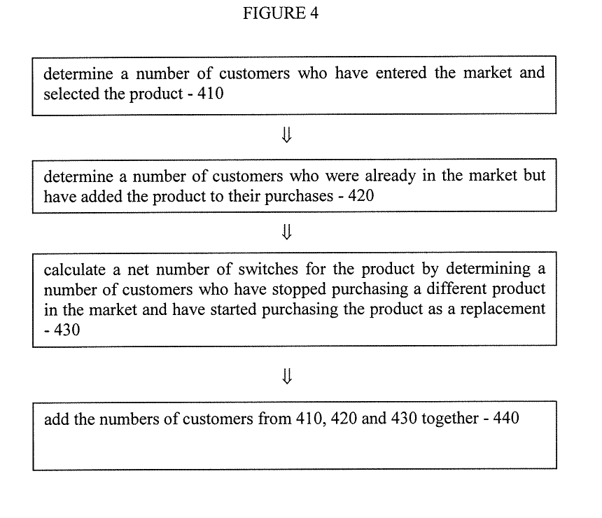

Returning to FIG. 2, at 240, the number of unique product selection decisions made for each of the products within the market is determined. This is usually the number of unique prescription decisions for each brand in the market. At a brand level, New Therapy Starts, Add-on Therapies, and Net Switch Therapy define unique prescription decisions. Referring to FIG. 4, a highly preferred arrangement is further discussed.

At 410, the number of customers who have entered the market and selected the product is determined. This is usually the number of New Therapy Starts.

At 420, the number of customers who were already in the market but have added the product to their purchases is determined. This is usually the number of Add-on Therapies.

At 430, the number of customers who have stopped purchasing a different product in the market and have started purchasing the product as a replacement is determined. This is usually the number of Switch To and is determined by analyzing the Monotherapy Switch and Concomitant Switch groups. This is usually the number of patients in the Net Switch Therapy group

Finally, at 440, the number of customers from Step 410, Step 420, and Step 430 are added together to determine the number of unique product selection decisions made for each of the products within the market.

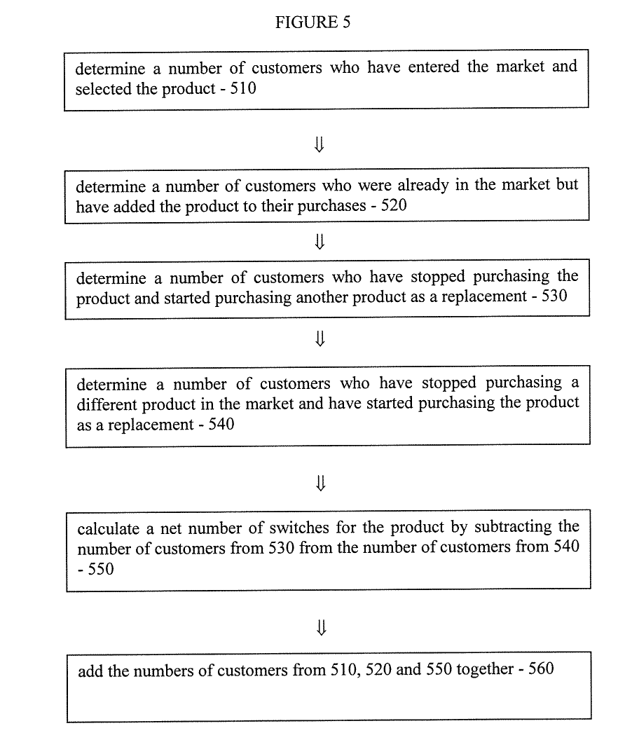

Referring to FIG. 5, an alternative process for determining the Net Switch Therapy for drugs that have already been on the market is described.

At 510, the number of customers who have entered the market and selected the product is determined. This is usually the number of New Therapy Starts.

At 520, the number of customers who were already in the market but have added the product to their purchases is determined. This is usually the number of Add-on Therapies.

At 530, the number of customers who have stopped purchasing the product and started purchasing another product as a replacement is determined. This is usually the number of Switch From, and is determined by analyzing the Monotherapy Switch and Concomitant Switch groups.

At 540, the number of customers who have stopped purchasing a different product in the market and have started purchasing the product as a replacement is determined. This is usually the number of Switch To and is determined by further analyzing the Monotherapy Switch and Concomitant Switch groups.

At 550, the net number of switches for the product is determined by subtracting the number of customers determined in step 530 from the number of customers determined in step 540. This is usually the number of patients in the Net Switch Therapy group.

At 560, the number of customers from 510, 520, and 550 are added together to determine the number of unique product selection decisions made for each of the products within the market.

Returning to FIG. 2, at 250, the number of unique product selection decisions made for each of the products within the market in relation to the total number of unique product selection decisions made within the market is calculated. This is usually the number of unique prescription decisions made by doctors to prescribe the brand, as a percentage of the total unique prescription decisions made by physicians in the market. This percentage is the Dynamic Capture Rate (DRx) of the product.

The foregoing merely illustrates the principles of the invention. Various modifications and alterations to the described embodiments will be apparent to those skilled in the art in view of the teachings herein. It will thus be appreciated that those skilled in the art will be able to devise numerous techniques which, although not explicitly described herein, embody the principles of the invention and are thus within the spirit and scope of the invention.

We claim:

1. A method for evaluating the performance of two or more products in a market comprising:
(a) defining a market;
(b) identifying the two or more competing products which exist in the market;
(c) determining a number of unique product selection decisions made within the market;
(d) determining a number of unique product selection decisions made for each of the products within the market; and
(e) calculating a percentage of unique product selection decisions made for each of the products within the market in relation to the total number of unique product selection decisions made within the market.

2. The method of claim 1 wherein the products are comprised of prescription pharmaceutical drugs and the unique product selection decisions are comprised of prescriptions for pharmaceuticals.

3. The method of claim 1 wherein the step of determining the number of unique product selection decisions made within the market comprises:
(f) determining a number of customers who have entered the market;
(g) determining a number of customers who were already in the market but have added another product to their purchases;
(h) adding the number of customers determined in step (f) to the number of customers determined in step (g).

4. The method of claim 3 wherein the number of customers who have entered the market comprise New Therapy Starts and the number of customers who have added another product comprise Add-on Therapies.

5. The method of claim 1 wherein the step of determining the number of unique product selection decisions made for each of the products within the market comprises:
(i) determining a number of customers who have entered the market and selected the product;
(j) determining a number of customers who were already in the market but have added the product to their purchases;
(k) calculating a net number of switches for the product by determining a number of customers who have stopped purchasing a different product in the market and have started purchasing the product as a replacement;
(l) adding the number of customers who have entered the market and selected the product, the number of customers who were already in the market but have added the product to their purchases, and the net number of switches for the product together.

6. The method of claim 1 wherein the step of determining the number of unique product selection decisions made for each of the products within the market comprises:
(m) determining a number of customers who have entered the market and selected the product;
(n) determining a number of customers who were already in the market but have added the product to their purchases;
(o) determining a number of customers who have stopped purchasing the product and started purchasing another product as a replacement;
(p) determining a number of customers who have stopped purchasing a different product in the market and have started purchasing the product as a replacement;
(q) calculating a net number of switches for the product by subtracting the number of customers who have stopped purchasing the product and started purchasing another product as a replacement from the number of customers who have stopped purchasing a different product in the market and have started purchasing the product as a replacement;
(r) adding the number of customers who have entered the market and selected the product, the number of customers who were already in the market but have added the product to their purchases, and the net number of switches for the product together.

7. The method of claim 5 wherein the number of customers who have entered the market and selected the product comprises New Therapy Starts for the product, the number of customers who were already in the market but have added the product to their purchases comprises Add-on Therapies for the product, and the net number of switches for the product comprises Net Switch Therapy for the product.

8. The method of claim 6 wherein the number of customers who have entered the market and selected the product comprises New Therapy Starts for the product, the number of customers who were already in the market but have added the product to their purchases comprises Add-on Therapies for the product, and the net number of switches for the product comprises Net Switch Therapy for the product.

9. The method of claim 7 wherein the customers comprise patients and each of the patients is classified into a patient type, the patient types selected from the group consisting of Monotherapy New to Market, Monotherapy Continued, Monotherapy Switch, Concomitant New to Market, Concomitant Continued, Concomitant Add-on, or Concomitant Switch.

10. The method of claim 8 wherein the customers comprise patients and each of the patients is classified into a patient type, the patient types selected from the group consisting of Monotherapy New to Market, Monotherapy Continued, Monotherapy Switch, Concomitant New to Market, Concomitant Continued, Concomitant Add-on, or Concomitant Switch.

11. A system for evaluating the performance of two or more products in a market comprising a processor, a data entry device, and a memory, operatively coupled to the processor, which contains instructions, which when accessed by the processor, cause the processor to:
(a) receive data defining a market;
(b) receive data identifying the two or more competing products which exist in the market;
(c) determine a number of unique product selection decisions made within the market;
(d) determine a number of unique product selection decisions made for each of the products within the market;
(e) calculate a percentage of unique product selection decisions made for each of the products within the market in relation to the total number of unique product selection decisions made within the market.

12. The system of claim 11 wherein the products are comprised of prescription pharmaceutical drugs and the unique product selection decisions are comprised of prescriptions for pharmaceuticals.

13. The system of claim 11 wherein the instruction causing the processor to determine the number of unique product selection decisions made within the market comprises instructing the processor to:
(f) determine a number of customers who have entered the market;
(g) determine a number of customers who were already in the market but have added another product to their purchases;
(h) add the number of customers determined in step (f) to the number of customers determined in step (g).

14. The system of claim 13 wherein the number of customers who have entered the market comprise New Therapy Starts and the number of customers who have added another product comprise Add-on Therapies.

15. The system of claim 11 wherein the instruction causing the processor to determine the number of unique product selection decisions made for each of the products within the market causes the processor to:
(i) determine a number of customers who have entered the market and selected the product;
(j) determine a number of customers who were already in the market but have added the product to their purchases;
(k) calculate a net number of switches for the product by determining a number of customers who have stopped purchasing a different product in the market and have started purchasing the product as a replacement;
(l) add the number of customers who have entered the market and selected the product, the number of customers who were already in the market but have added the product to their purchases, and the net number of switches for the product together.

16. The system of claim 11 wherein the instruction causing the processor to determine the number of unique product selection decisions made for each of the products within the market causes the processor to:
(m) determine a number of customers who have entered the market and selected the product;
(n) determine a number of customers who were already in the market but have added the product to their purchases;
(o) determine a number of customers who have stopped purchasing the product and started purchasing another product as a replacement;
(p) determine a number of customers who have stopped purchasing a different product in the market and have started purchasing the product as a replacement;
(q) calculate a net number of switches for the product by subtracting the number of customers who have stopped purchasing the product and started purchasing another product as a replacement from the number of customers who have stopped purchasing a different product in the market and have started purchasing the product as a replacement;
(r) add the number of customers who have entered the market and selected the product, the number of customers who were already in the market but have added the product to their purchases, and the net number of switches for the product together.

17. The system of claim 15 wherein the number of customers who have entered the market and selected the product comprises New Therapy Starts for the product, the number of customers who were already in the market but have added the product to their purchases comprises Add-on Therapies for the product, and the net number of switches for the product comprises Net Switch Therapy for the product.

18. The system of claim 16 wherein the number of customers who have entered the market and selected the product comprises New Therapy Starts for the product, the number of customers who were already in the market but have added the product to their purchases comprises Add-on Therapies for the product, and the net number of switches for the product comprises Net Switch Therapy for the product.

19. The system of claim 17 wherein the customers comprise patients and the instructions cause the processor to classify each of the patients into a patient type, the patient types selected from the group consisting of Monotherapy New to Market, Monotherapy Continued, Monotherapy Switch, Concomitant New to Market, Concomitant Continued, Concomitant Add-on, or Concomitant Switch.

20. The system of claim 18 wherein the customers comprise patients and the instructions cause the processor to classify each of the patients into a patient type, the patient types selected from the group consisting of Monotherapy New to Market, Monotherapy Continued, Monotherapy Switch, Concomitant New to Market, Concomitant Continued, Concomitant Add-on, or Concomitant Switch.
